(19) United States
(12) Patent Application Publication
(10) Pub. No.: US 2013/0257901 A1
(43) Pub. Date: Oct. 3, 2013

(54) USING AN ELECTRIC DISPLAY FOR DECORATION

(71) Applicants: YI-WEN CAI, Tu-Cheng (TW); SHIH-CHENG WANG, Tu-Cheng (TW)

(72) Inventors: YI-WEN CAI, Tu-Cheng (TW); SHIH-CHENG WANG, Tu-Cheng (TW)

(73) Assignee: HON HAI PRECISION INDUSTRY CO., LTD., Tu-Cheng (TW)

(21) Appl. No.: 13/437,996

(22) Filed: Apr. 3, 2012

(51) Int. Cl. G09G 5/00

(52) U.S. Cl. 345/619

(57) ABSTRACT

An electronic display such as electronic paper can decorate a structure by using a display system. The display system includes a content minding unit and a conversion unit. The content minding unit produces content information according to reference parameters generated by sensing devices. The conversion unit converts the content information into theme information. The display system transmits the theme information to the electronic display disposed in the structure, such that the electronic display can display scenes according to the theme information.

### BACKGROUND

1. Technical Field

The present disclosure relates to use of an electronic display for decoration, and particularly to a display system producing theme information for display according to the theme information which is converted from content information such as mood information, weather information, or circumstance information

2. Description of Related Art

A conventional electronic wallpaper displays scenes of images according to data signals received from an external device such as a computer. However, the data signals are usually provided according to a pre-stored image data which is manually chosen by a user, and cannot be changed until the user chooses a new image data.

What is needed, therefore, is a display system capable of overcoming the limitations described.

### BRIEF DESCRIPTION OF THE DRAWINGS

Many aspects of the present disclosure can be better understood with reference to the drawings. The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of a first embodiment of an electronic decoration system of the present disclosure.

FIG. 2A is a schematic diagram of an embodiment of the display device shown in FIG. 1.

FIG. 2B is a schematic diagram of another embodiment of a display device of an electronic decoration system of the present disclosure.

FIG. 3A is a block diagram of a second embodiment of an electronic decoration system of the present disclosure.

FIG. 3B is a schematic diagram of the disposition of the sensors 220 shown in FIG. 3A.

FIG. 4 is a block diagram of a third embodiment of an electronic decoration system of the present disclosure.

FIG. 5 is a flowchart of an embodiment of an electronic decoration method implemented through the electronic decoration system shown in FIG. 1.

### DETAILED DESCRIPTION

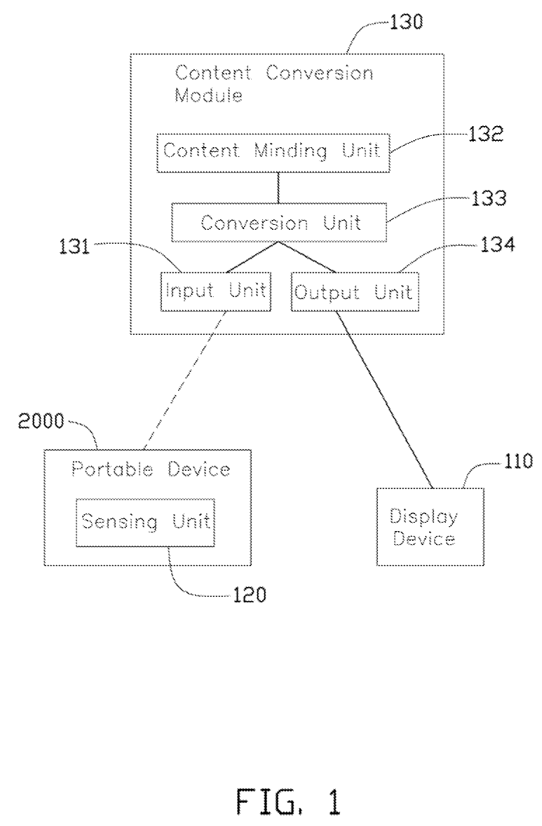

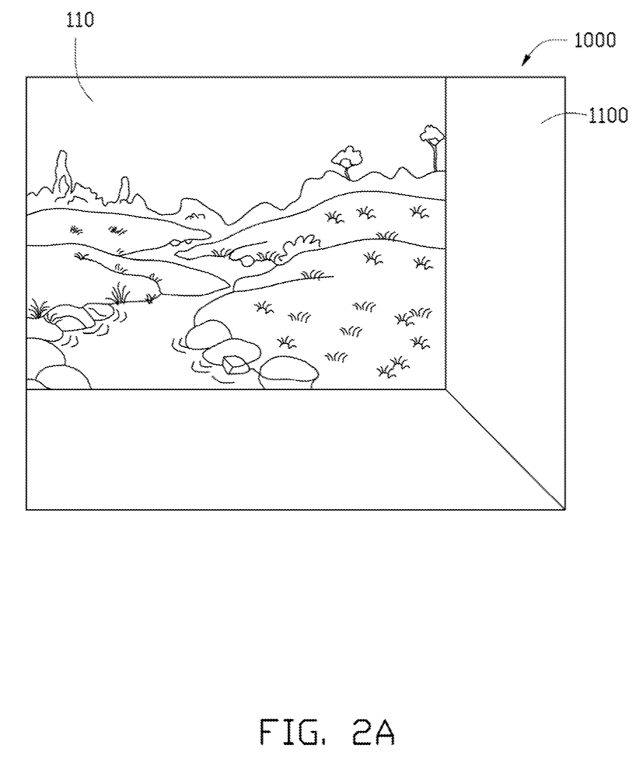

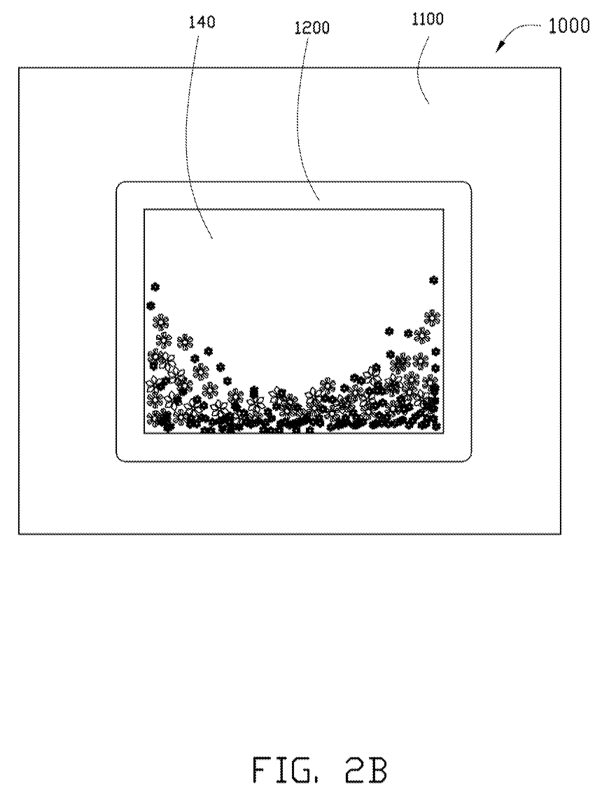

FIG. 1 is a block diagram of an embodiment of an electronic decoration system of the present disclosure. The electronic decoration system includes a display device 110 disposed in a structure 1000 (see FIG. 2A) such as a building or a vehicle. The electronic decoration system also includes a sensing unit 120, and a content conversion module 130.

FIG. 2A is a schematic diagram of an embodiment of the display device 110 shown in FIG. 1. In the illustrated embodiment, the display device 110 is electronic paper fixed on a surface of a wall 1100 of the structure 1000. In other embodiments, the display device 110 can be another type of electronic display such as OLED (organic light-emitting diode), and can be fixed on other portions of the wall 1100 such as an opening in the wall 1100. FIG. 2B is a schematic diagram of another embodiment of a display device 140 of an electronic decoration system of the present disclosure. The display device 140 is an AMOLED (active-matrix organic light-emitting diode) display disposed on a window 1200 of the structure 1000, which is substituted for a glass portion of a conventional window. The display device 140 can be a transparent AMOLED display which can adjust the transparency by changing, for example, the color or the pattern of a scene displayed by the display device 140.

The content conversion module 130 includes an input unit 131, a content minding unit 132, a conversion unit 133, and an output unit 134. In the illustrated embodiment, the content conversion module 130 is an electronic device separated from the display device 110 and the sensing unit 120. The sensing unit 120 is installed in a portable device 2000 such as a smart phone, a tablet computer, or a notebook computer, which generates body parameters P_{b} (not shown) of a human body, for example, pulse rate, breath rate, and/or body temperature. The sensing unit 120 can be, for example, a device including a camera of the portable device 2000 which captures images of a face of a bystander, determines the pulse rate of the bystander by detecting the changes of the color of the face of the bystander in the images. In addition, determines the breath rate of the bystander by detecting the motion frequency of the chest and the shoulders of the bystander in the images. The input unit 131 receives the body parameters P_{b} through a wireless network implemented according to a telecommunication standard such as Bluetooth, Wi-Fi, and GSM (Global System for Mobile Communications). The content minding unit 132 produces mood information Iₘ (not shown) according to the body parameters P_{b}. The mood information Iₘ can be produced by, for instance, determining the mood of the bystander such as pleasure, anger, sadness, or joy according to the pulse rate and the breath rate of the bystander obtained from the body parameters P_{b} by, for example, RSA (respiratory sinus arrhythmia) measurement. The conversion unit 133 converts the mood information Iₘ into theme information Iₜ (not shown) by, for instance, choosing an image or a video from a database, or generating a color or determining a brightness which is complementary or corresponding to the mood of the bystander, and transforming it into the theme information Iₜ. For example, when the bystander is sad, a funny image can be chosen, thereby entertaining the bystander. The theme information Iₜ is transmitted to the display unit 110 through the output unit 134. The display unit 110 can display scenes containing images or display scenes containing videos according to the theme information Iₜ, or modify the content of the scenes by, for instance, changing the brightness of the screen or modifying the images or the videos in the screen.

In other embodiments, the content conversion module 130 can be integrated with the display device 110 and/or the sensing unit 120. The sensing unit 120 can be disposed in other methods such as fixed on the wall 1100 of the structure 1000 or outside of the structure 1000. In addition, the sensing unit 120 can generate other types of parameters, for example, environmental parameters Pₑ (not shown) of the environment such as air temperature, humidity, luminosity, visibility, wind velocity, atmospheric pressure, cloudiness, and/or evaporation, for example. Correspondingly, the content minding unit 132 produces weather information I_{w} (not shown) according to the environmental parameters Pₑ. The conversion unit 133 converts the weather information I_{w} into the theme information Iₜ by, for instance, choosing an image or a video from a database, or generating a color or determining a brightness which is corresponding or complementary to the weather, and transforming it into the theme information Iₜ. For example, when it is raining, an image of rain can be chosen, thereby adding themes of nature to the structure 1000. Furthermore, the sensing unit 120 can include different types of sensors which generate different types of parameters such as the body parameters P_{b} and the environmental parameters Pₑ. Correspondingly, the content minding unit 132 produces content information according to the body parameters P_{b} and the environmental parameters Pₑ, and the conversion unit 133 converts the content information into the theme information Iₜ.

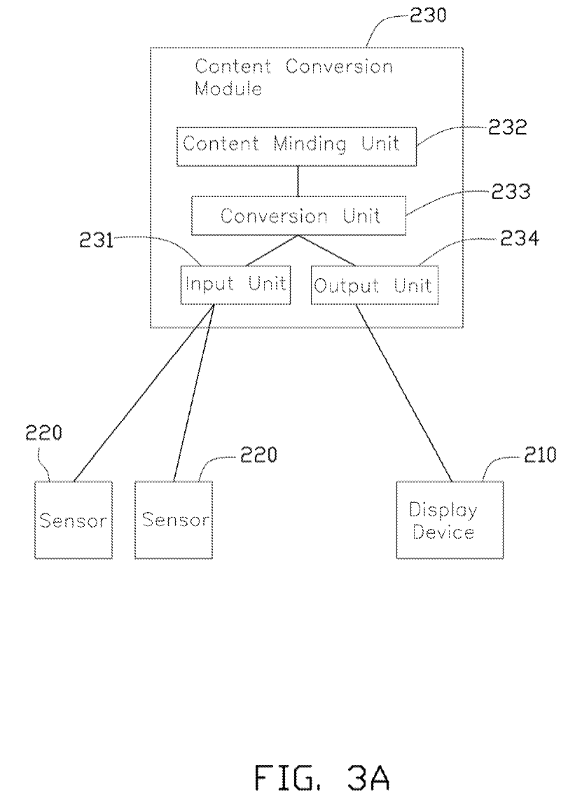

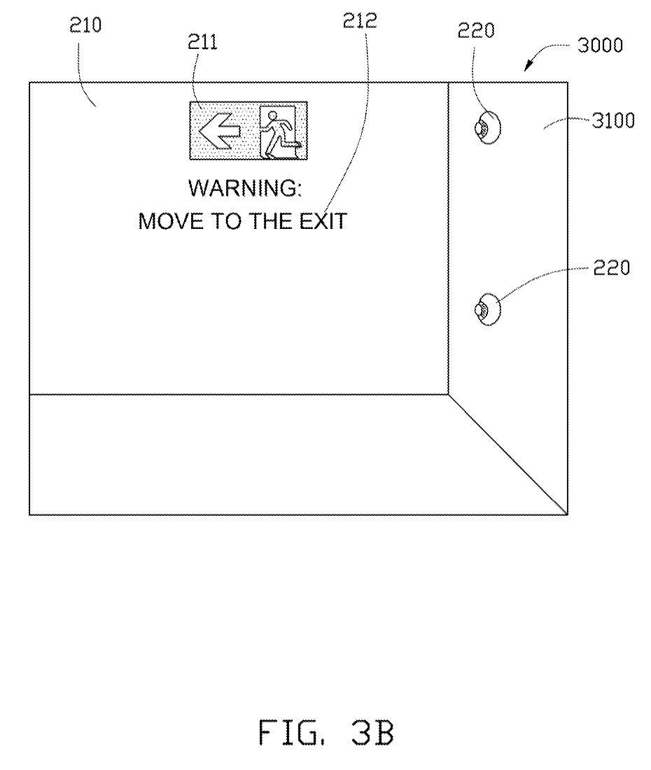

FIG. 3A is a block diagram of a second embodiment of an electronic decoration system of the present disclosure. The electronic decoration system includes a display device 210 disposed on a wall 3100 of a structure 3000 (see FIG. 3B), sensors 220, and a content conversion module 230. The electronic decoration system can be powered by a UPS (uninterruptible power supply), and the display device 210 can be made from fireproof materials. FIG. 3B is a schematic diagram of the disposition of the sensors 220 shown in FIG. 3A. The display device 210 displays an emergency sign 211 at an upper portion of a scene displayed by the display device 210, and displays an emergency message 212 below the emergency sign 211. The sensing unit 220 is disposed on the wall 3100, which generates emergency-related parameters Pₑ (not shown), for example, air temperature and/or smoke density. The content conversion module 230 includes an input unit 231, a content minding unit 232, a conversion unit 233, and an output unit 234. The content minding unit 232 produces event information Iₑ (not shown) according to the emergency-related parameters Pₑ. The location of the emergency sign 211 on the scene can be changed according to the event information Iₑ. The emergency message 212 is displayed according to the event information Iₑ. In the illustrated embodiment, the sensors 220 are smoke sensors disposed on different portions of the wall 3100, which are at different heights, thereby detecting the level of smoke. When the level of smoke becomes lower, for example, lower than 1.5 meters, the emergency sign 211 is moved to a lower portion of the screen, for example, lower than 0.5 meters, such that the emergency sign 211 can be seen in heavy smoke. The emergency message 212 is a warning message relating to an emergency detected by the sensors 220. In other illustrated embodiment, the sensors 220 can be another type of sensor, which generates other emergency-related parameters Pₑ such as parameters of thermal images, and the sensors 220 can be disposed in other methods according to actual situations.

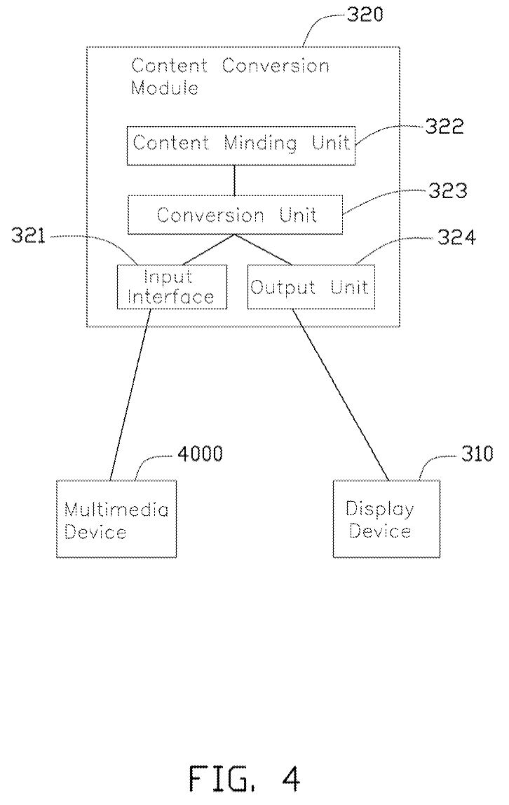

FIG. 4 is a block diagram of a third embodiment of an electronic decoration system of the present disclosure. The electronic decoration system includes a display device 310 disposed on a wall of a structure and a content conversion module 320. The content conversion module 320 includes an input interface 321, a content minding unit 322, a conversion unit 323, and an output unit 324. The input interface 321 is an interface for receiving multimedia signals from a multimedia device 4000, which generates multimedia content parameters Pₘ (not shown) according to the multimedia signals. The multimedia content parameters Pₘ can be, for example, text, still image, video, and/or audio. The content minding unit 322 produces circumstance information I_{c} (not shown) according to the multimedia content parameters Pₘ. The circumstance information I_{c} can be produced by, for instance, determining the circumstance of a video such as the scene or the atmosphere according to the video itself and/or the subtitle of the video obtained from the content parameters Pₘ by analyzing the content of the video and/or the subtitle. The conversion unit 323 converts the circumstance information I_{c} into the theme information Iₜ by, for instance, choosing an image or a video from a database, or generating a color or determining a brightness which corresponds to the circumstance of the video, and transforming it into the theme information Iₜ.

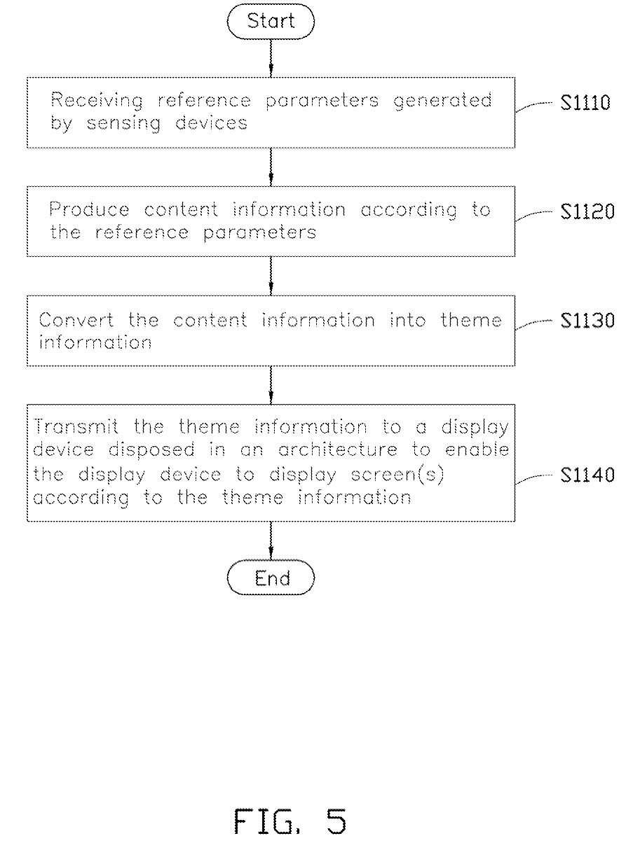

FIG. 5 is a flowchart of an embodiment of an electronic decoration method implemented through the electronic decoration system shown in FIG. 1. The electronic decoration method of the present disclosure follows. Depending on the embodiment, additional steps may be added, others removed, and the ordering of the steps may be changed.

In step S1110, reference parameters such as the body parameters P_{b} or the environmental parameters Pₑ generated by the sensing unit 120 is received. In other embodiments (see FIG. 3A and FIG. 4), the reference parameters can be the emergency-related parameters Pₑ or the multimedia content parameters Pₘ.

In step S1120, content information such as the mood information Iₘ or the weather information I_{w} is produced according to the reference parameters. In other embodiments (see FIG. 3A and FIG. 4), the content information can be the event information Iₑ or the circumstance information I_{c}.

In step S1130, the content information is converted into the theme information Iₜ.

In step S 1140, the theme information Iₜ is transmitted to the display device 110 disposed in the structure 1000 to enable the display device 110 to display scene(s) according to the theme information Iₜ.

The electronic decoration system and the electronic decoration method are capable of changing scenes displayed by a display device disposed in a structure automatically, which increase the decorative effect of the display device for the structure.

While the disclosure has been described by way of example and in terms of preferred embodiment, the disclosure is not limited thereto. On the contrary, it is intended to cover various modifications and similar arrangements as would be apparent to those skilled in the art. Therefore the range of the appended claims should be accorded the broadest interpretation so as to encompass all such modifications and similar arrangements.

What is claimed is:

1. An electronic decoration system, comprising:
a display unit disposed in a structure;
one or more sensing units generating one or more reference parameters;
a content minding unit producing content information according to the one or more reference parameters; and
a conversion unit converting the content information into theme information, wherein the display unit displays one or more scenes according to the theme information.

2. The electronic decoration system of claim 1, wherein the display unit is disposed on a wall of the structure to fix on at least one of a surface of the wall and an opening of the wall.

3. The electronic decoration system of claim 1, wherein the display unit is an electronic paper.

4. The electronic decoration system of claim 1, wherein the content information comprises one or more mood information, each of the one or more sensing units comprises one or more sensors generating one or more body parameters, the content minding unit produces the one or more mood information according to the one or more body parameters.

5. The electronic decoration system of claim 4, wherein the one or more body parameters comprising at least one of pulse rate, breath rate, and body temperature.

6. The electronic decoration system of claim 1, wherein the content information comprises one or more weather information, each of the one or more sensing units comprises one or more sensors generating one or more environmental parameters, the content minding unit produces the one or more weather information according to the one or more environmental parameters.

7. The electronic decoration system of claim 6, wherein the one or more environmental parameters comprising at least one of air temperature, humidity, luminosity, visibility, wind velocity, atmospheric pressure, cloudiness, and evaporation.

8. The electronic decoration system of claim 1, wherein the content information comprises one or more circumstance information, each of the one or more sensing units comprises one or more input interfaces generating one or more multimedia content parameters according to one or more multimedia signals received from one or more multimedia devices, the content minding unit produces the one or more circumstance information according to the one or more multimedia content parameters.

9. The electronic decoration system of claim 8, wherein the one or more multimedia content parameters comprises at least one of text, still image, video, and audio.

10. The electronic decoration system of claim 1, wherein the display unit displays one or more emergency signs at a portion of a scene displayed by the display unit, the content information comprises one or more event information, each of the one or more sensing units comprises one or more sensors generating one or more emergency-related parameters, the content minding unit produces the one or more event information according to the one or more emergency-related parameters, the location of the one or more emergency signs on the scene displayed by the display unit are determined according to the one or more event information in the theme information.

11. The electronic decoration system of claim 10, wherein the display unit displays one or more emergency messages according to the one or more event information in the theme information.

12. A display system for a display device disposed in a structure, comprising:
a content minding unit producing content information according to one or more reference parameters generated by one or more sensing devices; and
a conversion unit converting the content information into theme information;
wherein the display system transmits the theme information to the display device disposed in the structure to enable the display device to display one or more scenes according to the theme information.

13. The display system of claim 12, wherein the content information comprises one or more mood information, each of the one or more sensing units comprises one or more sensors generating one or more body parameters, the content minding unit produces the one or more mood information according to the one or more body parameters.

14. The display system of claim 12, wherein the content information comprises one or more weather information, each of the one or more sensing units comprises one or more sensors generating one or more environmental parameters, the content minding unit produces the one or more weather information according to the one or more environmental parameters

15. The display system of claim 12, wherein the content information comprises one or more circumstance information, each of the one or more sensing units comprises one or more input interfaces generating one or more multimedia content parameters according to one or more multimedia signals received from one or more multimedia devices, the content minding unit produces the one or more circumstance information according to the one or more multimedia content parameters.

16. An electronic decoration method for a display device disposed in a structure, comprising:
receiving one or more reference parameters generated by one or more sensing devices;
producing content information according to the one or more reference parameters;
converting the content information into theme information; and
transmitting the theme information to the display device disposed in the structure to enable the display device to display one or more scenes according to the theme information.

17. The electronic decoration method of claim 16, wherein the one or more reference parameters comprise one or more body parameters, the content information comprises one or more mood information, the step of producing the content information comprises:
producing the one or more mood information according to the one or more body parameters.

18. The electronic decoration method of claim 16, wherein the one or more reference parameters comprise one or more environmental parameters, the content information comprises one or more weather information, the step of producing the content information comprises:
producing the one or more weather information according to the one or more environmental parameters.

19. The electronic decoration method of claim 16, wherein the one or more reference parameters comprise one or more multimedia content parameters generated according to one or more multimedia signals received from one or more multimedia devices, the content information comprises one or more circumstance information, the step of producing the content information comprises:
producing the one or more circumstance information according to the one or more multimedia content parameters.

20. A computer program product comprising a computer readable storage medium and an executable computer program mechanism embedded therein, the executable computer program mechanism comprising instructions for:
receiving one or more reference parameters generated by one or more sensing devices;
producing content information according to the one or more reference parameters;
converting the content information into theme information; and
transmitting the theme information to a display device disposed in a structure to enable the display device to display one or more scenes according to the theme information.
